(19) United States
(12) Patent Application Publication
(10) Pub. No.: US 2014/0019211 A1
(43) Pub. Date: Jan. 16, 2014

(54) Operation State Display Method

(71) Applicants: Cai Ling Chen, Taipei city (TW); Bing Feng Twu, Taipei city (TW)

(72) Inventors: Cai Ling Chen, Taipei city (TW); Bing Feng Twu, Taipei city (TW)

(21) Appl. No.: 13/980,880

(22) PCT Filed: Jan. 20, 2011
(86) PCT No.: PCT/CN11/70426

§ 371 Date: Sep. 23, 2013

(51) Int. Cl. G06Q 10/06

(52) U.S. Cl. CPC G06Q 10/0637
USPC 705/7.36

(57) ABSTRACT

Provided is an operation state display method used for an electronic device to display the operation states of an original business entity and a derived business entity. The operation state display method includes the following steps: the electronic device acquires the operation information of the original business entity and the derived business entity, wherein the electronic device generates a systematic image, and then the electronic device displays the systematic image. The step for generating a systematic image includes, according to the operation information of the original business entity, the electronic device generates an original business entity image, wherein a derived business entity image is generated. The electronic device sets with a systematic representation and a relative position of the original business entity image and the derived business entity image to form the systematic image, wherein the systematic representation represents that there is an origin-deriving relationship between the original business entity image and the derived business entity image.

### BACKGROUND OF THE PRESENT INVENTION

1. Field of Invention

The present invention relates to an operation state display method for an electronic device, and more particularly to display the operation states among business entities in a concise method.

2. Description of Related Arts

It is important for business owners to control the operation statess of a business effectively and quickly. This is especially important for business models that differ from traditional business models such as direct selling and chaining business. These business models consist of many independent business operation entities, whose management methods are different from the management method of traditional companies that utilizing single whip rules to manage the entire company. Each member of the business entities are capable of deciding the manner and direction of operation by themselves under some basic operating rules. Therefore, the operation statess of each of these business members must be controlled.

Usually, the business owners control the operation statess of business through the text reports of the business operation statess. However, it is very time and energy consuming to read and understand the traditional text reports, especially when the text reports contain an immense amount of information. On the other hand, because the structure of direct selling is upline-downline, so that traditional text reports are not convenient to represent the operation statess of the direct selling. This is especially true for the multi-level direct selling system (for example, the direct selling system of Amway company). When the number of levels are large, the traditional text reports that represent the operation statess are very complex and hard to understand. For example, a direct distributor has 500 direct downline distributors. It is assumed that the operating information (such as name, contact information, the date of direct distributor, pin, title, etc.) of each downline is represented only in three lines, and an A4 sized paper is prints approximately 25 lines about 5 operating information downlines. In other words, to print the operation statess of 500 downlines, 10 pages are needed and the operation statess of each of downline are only printed 3 on lines. If the operation statess downlines are need to be printed in more detail or more information of the downlines is required, more pages are needed. If one of the 500 downlines requires particular attention, it is difficult to quickly identify it among these 10 pages. The above recited represents traditional methods of traditional text reports which are capable of improving.

Besides knowing the operation statess of each businesses well, in order to control the operation statess of businesses effectively and quickly it is more important to respond quickly and appropriately to each new state that is generated in the business entity. For example, the business entity generated new state is contacted by phone, email, video phone or online chat. However, in traditional methods, business owners spend a lot of time discovering the new state of a business entity, and spend more time to search the contact information of the business entity, such as phone number, email account, video phone account or online chat account, and then the contact is implemented. These tasks are trivial and waste time, time which can be better utilized to improve efficiency.

### SUMMARY OF THE PRESENT INVENTION

The invention is advantageous in that it provides an operation state display method for an electronic device, which displays operation statess of business entities in a concise method.

Another advantage of the invention is to provide an operation state display method for an electronic device, which provides controlling operation statess of business entities in a more convenient and efficient form for users.

Another advantage of the invention is to provide a systematic image generation method for generating a systematic image which represents the operation statess of business entities in a more concise method.

In a preferred embodiment, the operation state display method of the present invention for an electronic device to display the operation statess of an original business entity and a derived business entity, wherein the original business entity and the derived business entity have an origin-deriving relationship. The original business entity has operating information of the original business entity, and the derived business entity has operating information of the derived business entity.

The operation state display method of the present invention comprises the steps of: acquiring operating information of the original business entity and the derived business entity from an electronic device, generating a systematic image by the electronic device, and displaying the systematic image through the electronic device. The step of generating a systematic image further comprises the steps of: the image of the original business entity is generated through the electronic device in accordance with operating information of the business entity, the image of the derived business entity is generated through the electronic in accordance with operating information of the derived business entity, the relative position among the image of the original business entity is configured, and the image of the derived business entity is configured to form a systematic image through the electronic device in a systematic representation, wherein the systematic representation represents the original business entity and the derived business entity having an origin-deriving relationship.

In other embodiments, the operation state display method comprises the steps of: acquiring the systematic image by the electronic device, and displaying the systematic image by the electronic device. Generating the systematic image comprises the steps of: generating an original business entity image in accordance with the operating information of the original business entity through a headquarters end, generating an image of the derived business entity in accordance with operating information of the derived business entity through the headquarters end, configuring a relative position about the original business entity image and the derived business entity image to form a systematic image through the headquarters end in a systematic representation, wherein, the systematic representation represents the original business entity and the derived business entity have an origin-deriving relationship.

The step of generating the systematic image further comprises the step of differentiation representation for the systematic image according to operating information of the original business entity and the derived business entity. The operation state display method further comprises the derived business entity images that are selectively hidden. The operation state display method further comprises a marking image displayed in adjacent to the derived business entity image, wherein the marking image is generated according to the operating information of the derived business entity.

The operation state display method further comprises detecting a selection signal through an electronic device. The selection signal, corresponding to the original business entity image or the operating information of the original business entity, is then displayed by the electronic device. An event is then implemented through the electronic device the selection signal corresponding to one of the contents of operating information of the original business entity or the derived business entity.

The origin-deriving relationship comprises an upline-downline relationship of direct selling, headquarters-branch relationship of chaining business, franchiser-franchisee relationship of franchise, and leader-crew relationship of insurance. The original business entity and the derived business entity comprise direct distributors, personal enterprises, companies, franchisers, stores, and insurance salesmen. The systematic image is a beaded image, a planetary-system image, or a treeform syntax.

The generation method of the systematic image comprises the steps of: the operating information of the original business entity and the derived business entity are acquired through a computer, wherein the original business entity and the derived business entity have an origin-deriving relationship. A systematic image is then generated and outputted through the computer, wherein generating the systematic image comprises the steps of: an original business entity image is generated according to operating information of the original business entity through the computer; and a derived business entity image is generated in accordance with operating information of the derived business entity through the computer. The relative position of the original business entity image and the derived business entity image are configured to form a systematic image through the computer in a systematic representation method, wherein the systematic representation method represents the original business entity image and the derived business entity image having an origin-deriving relationship.

The systematic image generation method comprises the operating information of the original business entity and the derived business entity that is acquired from the library. The systematic image generation method further comprises an adjacent marking image derived from the business entity image that is generated, wherein the marking image is generated according to operating information of the derived business entity. The systematic image is provided for downloading and displaying through the electronic device, browsing on network, or printing.

### BRIEF DESCRIPTION OF THE DRAWINGS

FIG. 1 is a flow chart according to the embodiment of the present invention.

FIG. 2 is a block diagram illustrating a circuit according to the preferred embodiment of the present invention.

FIG. 3A is a schematic diagram according to the embodiment of the present invention.

FIG. 3B is a schematic diagram according to the preferred embodiment of the present invention.

FIG. 4A is a schematic diagram illustrating a planetary system image according to the embodiment of the present invention.

FIG. 4B is a schematic diagram illustrating a dendrogram according to the embodiment of the present invention.

FIG. 5B is a schematic diagram illustrating the display marking image according to the embodiment of the present invention.

FIG. 6A is a schematic diagram illustrating a selection signal of the original business entity image that is detected through an electronic device according to the embodiment of the invention.

FIG. 6B is a schematic diagram illustrating the operating information of the original business entity that is displayed through an electronic device according to the embodiment of the invention.

FIG. 6C is a schematic diagram illustrating a selection signal of the derived business entity image that is detected through an electronic device according to the embodiment of the invention.

FIG. 6D is a schematic diagram illustrating the operating information of the derived business entity that is displayed through an electronic device according to the embodiment of the present invention.

FIG. 7 is a schematic diagram illustrating a video chart between users through an electronic device according to the embodiment of the present invention.

FIG. 8 is a schematic diagram illustrating a showing event list through an electronic device according to the embodiment of the present invention.

### DETAILED DESCRIPTION OF THE PREFERRED EMBODIMENT

The present invention provides an operation state display method for an electronic device, wherein the electronic device, such as tablet PC, laptop, mobile phone, personal digital assistant (PDA), electronic reader, digital media frame, digital walkman, digital dictionary, or a Global Positioning System (GPS) navigation device, has better portability, wherein the portability is not a limitation of the electronic device. The electronic device can also be an electronic product which bigger and heavier, such as a desktop computer or media TV.

In the preferred embodiment, an operation state display method of the present invention for an electronic device displays the operation statess of the original business entity and the derived business entity, wherein the original business entity and the derived business entity have an origin-deriving relationship. More specifically, the origin-deriving relationship between the original business entity and the derived business entity means that the original business entity is the origin of the derived business entity; in other words, the derived business entity is derived from the original business entity. For example, in the preferred embodiment the original business entity and the derived business entity are the distributor, which is an individual business owner that sells directly. The origin-deriving relationship relates to the upline-downline (referee-referral) relationship of direct selling, wherein the upline is the original business entity and the downline is derived business entity. However, the original business entity and the derived business entity can be a personal enterprise, a company, a distributor, a store, or an insurance salesman The origin-deriving relationship can be a headquarters-branch relationship of chaining business (the headquarters is the original business entity and the branch is the derived business entity), or a leader-crew relationship of the insurance industry (leader is the original business entity and the crew is the derived business entity).

The original business entity has the operating information of the original business entity, and the derived business entity has the operating information of the original business entity, wherein the operating information includes, but is not limited to, the name of business entity, the contact information, the established date, the birthday, the system, the pin, the turnover, the number of transactions, the logistics states of products, the original business entity, the derived business entity, and/or the number of the derived business entity, etc. The operating information comprises all the information relating to business operation, wherein the sampling time of operating information is not an immediate limitation, but also can be a previous specific point in time or a time interval.

Referring to FIG. 1 of the drawing, a flow chart of an operation state display method is illustrated according to the embodiment of the present invention. The operation state display method comprises the steps of step 1010, 1030, and 1050 that are specifically described as the following:

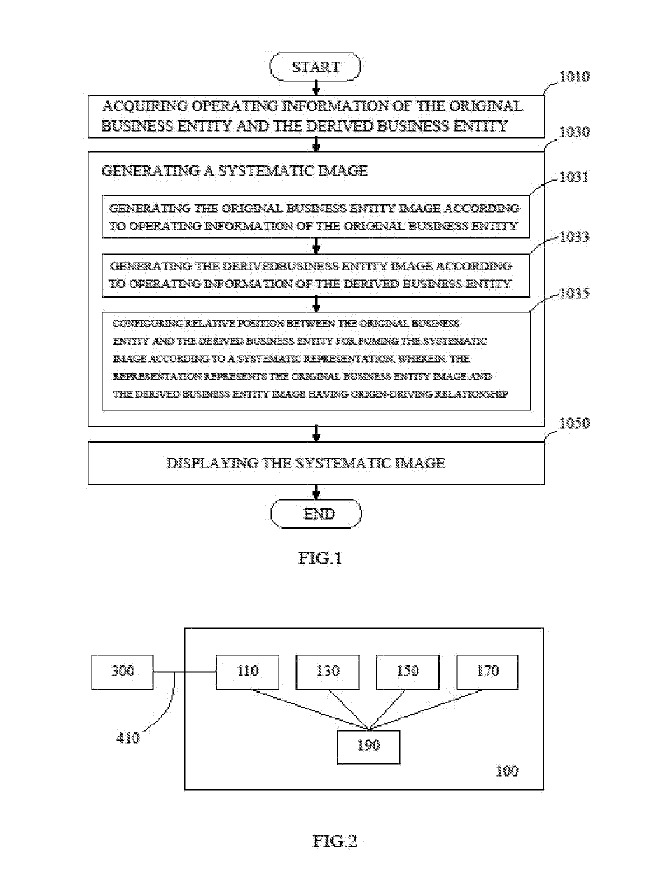

Step 1010, the operating information of the original business entity and the derived business entity are acquired through an electronic device. More specifically in the preferred embodiment, as shown on FIG. 2, the electronic device 100 comprises a communication device 110, a displaying device 130, a storage device 150, an input device 170, and an arithmetic device 190. The communication device 110 further comprises a network adapter or a communication chip for establishing a first communication channel 410 of a communication network in accordance with internet, mobile phone communication, or other communication protocols. The displaying device 130 prefers, but is not limited to, a touch screen. The storage device 150 comprises a high-speed random access memory, and further comprises a non-volatile storage ability, such as a one or more disc storage device, a flash storage device, or other non-volatile solid storage device. In another embodiment, the storage device 150 further comprises a storage device away from the arithmetic device 190. For example, an additional network storage device connected with the internet, one or more intranets, a local area network (LAN), WLAN, storage area network (SAN), or a combine network through the communication 110. The arithmetic device 190 prefers a central processing unit (CPU), which is capable of implementing various software programs and/or instruction sets so as to implement various functions of the electronic device 100 and the process data.

In the preferred embodiment, the operating information of the business entity and the derived business entity are preferred to be stored in a headquarters end 300 which is independent and away from the electronic device 100, as shown on FIG. 2. The first communication channel 410 is established between the electronic device 100 and the headquarters end 300 through the communication device 110. Operating information of the business entity and the derived business entity is outputted through the headquarters end 300, transmitted through the first communication channel 410, and acquired by the electronic device 100. In other words, in the preferred embodiment, the electronic device 100 downloads (acquires) operating information of the original business entity and the derived business entity through the headquarters end 300, wherein the headquarters end 300 can be a computer or a server, and the downloaded operating information of the original business entity and the derived business entity are processed directly through the arithmetic device 190, or the downloaded operating information of the original business entity and the derived business entity are first stored in the storage device 150 and then acquired and processed through the arithmetic device 190 while the downloaded operating information of the original business entity and the derived business entity is necessary for use.

However in other embodiments, the operating information of the business entity and the derived business entity are stored in a storage medium (not shown in Figures), and the electronic device 100 acquires the operating information of the business entity and the derived business entity through the input device 170. In other words, the electronic device 100 acquires the operating information of the original business entity and the derived business entity from the storage medium, wherein the storage medium comprises a medium that is capable of storing and acquiring information in accordance with the physical principles, chemical principles, or biological principles, including, but not limited to, a storage type disk, compact disk, flash memory card, deoxyribonucleic acid (DNA) chip, or ribonucleic acid (RNA) chip.

Step 1030, a systematic image is generated through the electronic device, comprising the steps of: step 1031, an original business entity image is generated according to the operating information of the original business entity image through the electronic device. Step 1033, a derived business entity image is generated in accordance with the operating information of the derived business through the electronic device. Step 1035, a relative position between the original business entity image and the derived business entity image is configured according to a systematic representation method for forming a systematic image through the electronic device, wherein the systematic representation represents the original business entity and the derived business entity having an origin-deriving relationship.

Step 1050, the systematic image is displayed through the electronic device. In the preferred embodiment, as shown on FIG. 2, the electronic device 100 has a displaying device 130 for displaying the systematic image. In other words, the systematic image is displayed on the displaying device 130 that is built-in the electronic device 100 after the systematic image is generated through the electronic device 100, wherein the displaying device 130 is configured on the electronic device 100, and the device can be embodied as a screen, and preferred as a touch screen. However in other embodiments, the displaying device 130 can be a peripheral device for the electronic device 100. For example, a peripheral display or a peripheral projection device. After the systematic image is generated and transmitted to the peripheral display or the peripheral projection device through the electronic device 100, the systematic image is displayed on the peripheral display or the peripheral projection device.

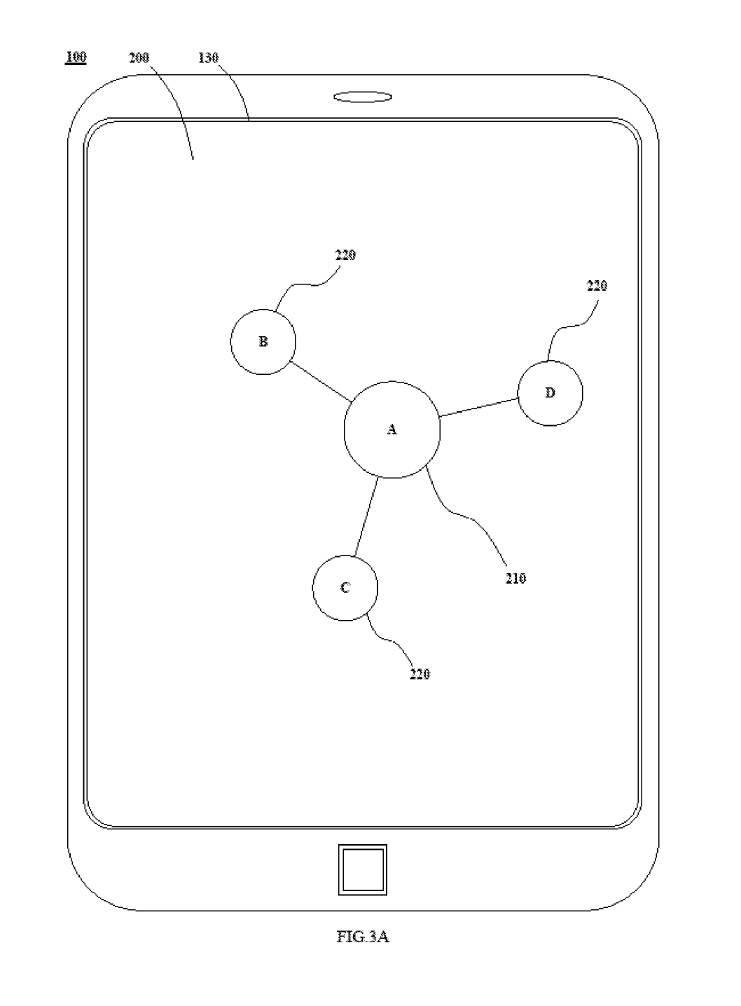

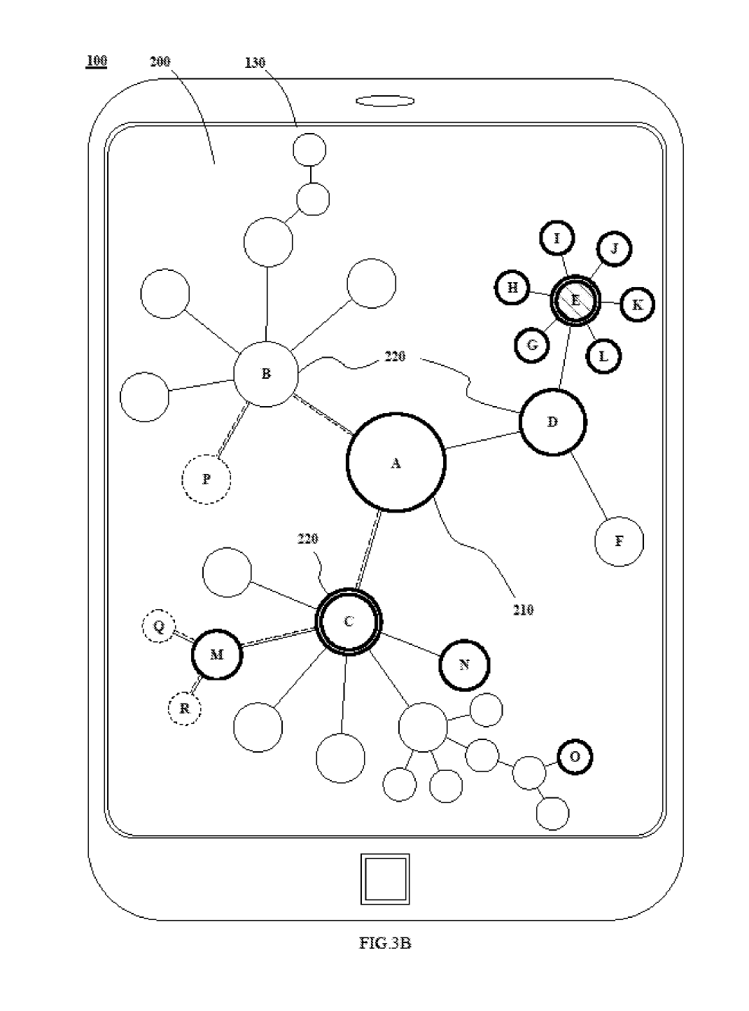

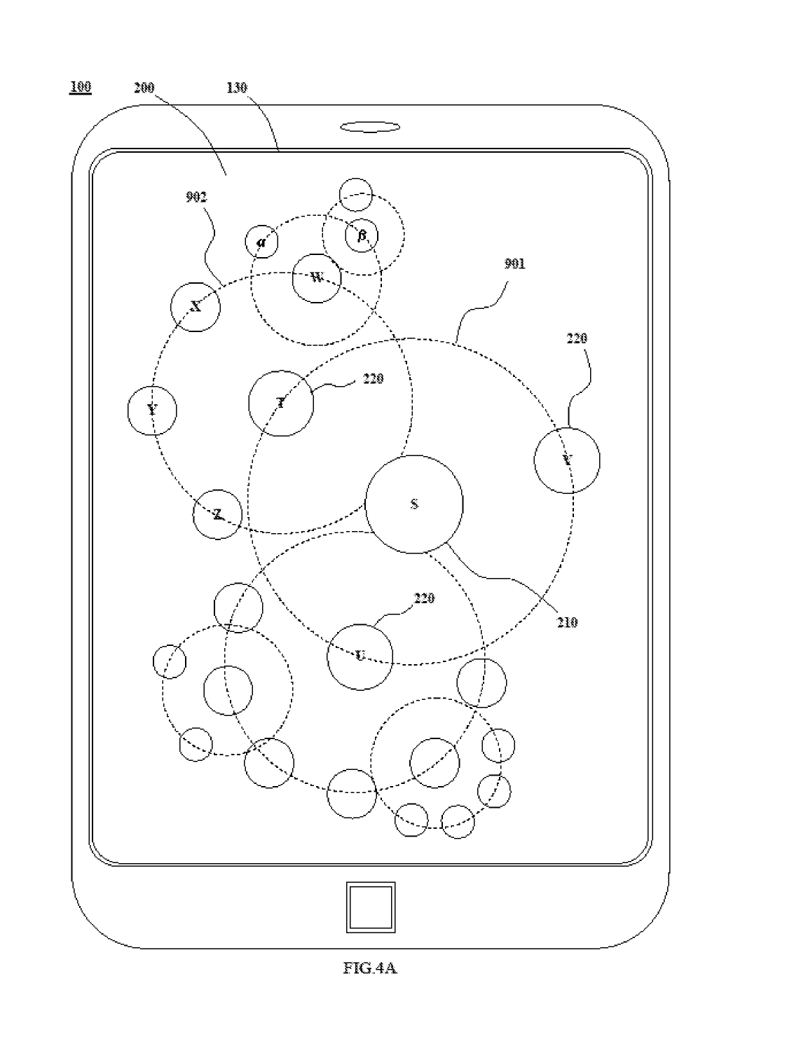

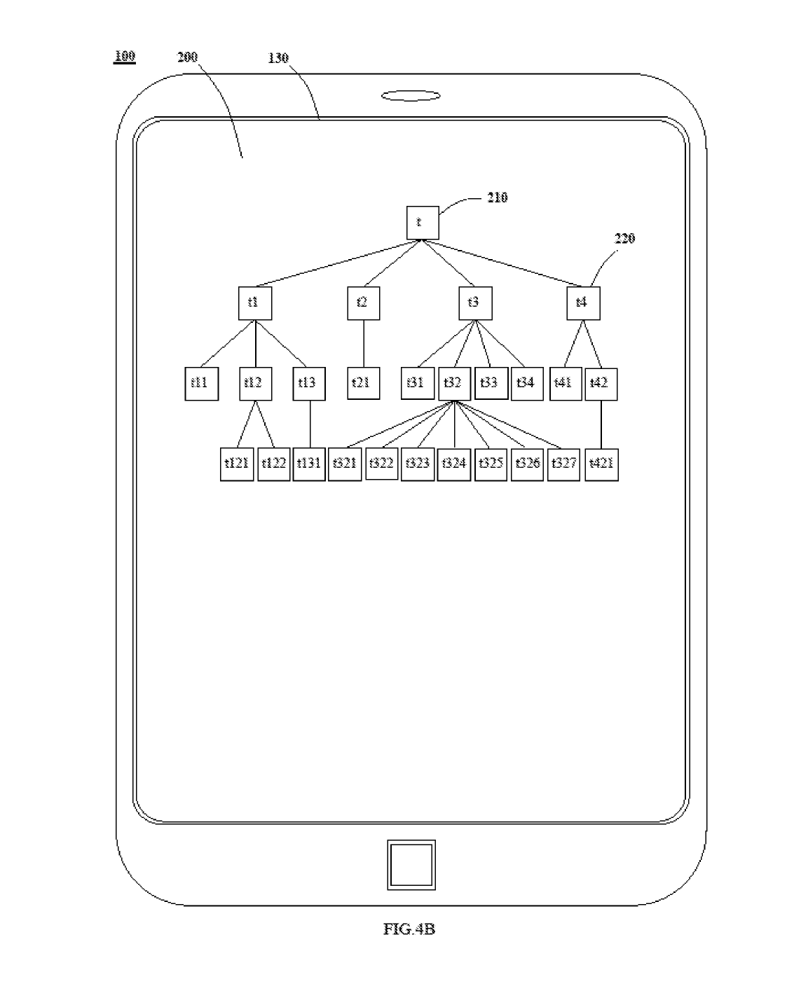

More specifically in the preferred embodiment, as shown in FIG. 2, the storage device 150 of the electronic device 100 contains a software program for generating the systematic image. After the operating information of the original business entity and the derived business entity are acquired through the electronic device 100, the software program for generating the systematic image is implemented through the arithmetic device 190. According to the operating information of the original business entity and the derived business entity, the original business entity image 210 and the derived business entity image 220 are generated respectively, as shown on FIG. 3A, wherein the original business entity image 210 and the derived business entity image 220 are preferably, but are not limited to, a of representation of the circle. The systematic image 200 are preferably, but is not limited to, that of a beaded image.

As shown in FIG. 3A, the original business entity and the derived business entity respectively represent the upline and downline (referee and referral) of direct selling. The operating information of the original business entity comprises the name of upline A (name of the original business entity). The operating information of the derived business information comprises names of downline B, C, and D (name of the derived business entity), and relative information about downline B, C, and D is sponsored by upline A according to the “referee” system (the information of the original business entity of the derived business entity). The relative information about downline B, C and D is sponsored by upline A according to the “referee” system, but this is not a limitation of the representation code. For example, downline B, C, and D both have the code A01, which represents that the downline B, C, and D are the first generation downline sponsored and established through the upline A. The arithmetic device 190 (referring to FIG. 2) can implement the software program for generating a systematic image of the original business entity image 210 with marking A in accordance with the name of upline A of the operating information of the original business entity, and generating the derived business entity images 222 with marking B, C, and D according to the name of downline B, C, and D of the operating information of the derived business entity. Then the representation of the beaded method is utilized according to the relative information about downline B, C, and D of the operating information of the derived business entity, wherein the original business entity image 210 with marking A is regarded as a central bead, and the derived business entity image 220 with marking B, C and D are regarded as connected beads. In order words, the position of the original business entity image 210 relative to the derived business entity image 220 is a central position, so that the original business entity image 210 and the derived business entity image 222 form a beaded image.

In this embodiment, the systematic representation means that the original business entity image 210 is regarded as the central bead of the beaded image, and the derived business entity image 220 is regarded as the connected bead of the beaded image. The derived business entity image 220 is configured on the periphery of the original business entity image 210 and linked together to form a beaded image that is regarded as the systematic image 200. Since the derived business entity image 220 and the original business entity image 210 link in series, the systematic representation method can represent the origin-deriving relationship between the original business entity and the derived business entity. In other words, upline A and downline B, C, and D have an upline-downline relationship between them. In another view in this embodiment, the direct selling network is formed by upline A and downline B, C, and D. The systematic image 200 represents the direct selling network in a beaded representation method.

More time and energy is spent trying to read and understand the traditional text reports, especially if there is an immense amount of information (for example, an immense of number or levels of the downline), and also traditional text reports are harder to understand. In the present invention, the operating information of the business entity is displayed concisely by utilizing the systematic representation to generate the systematic image 200 (in this embodiment it is operating information of the directing selling network). It is convenient for the user to browse the operating information of the business entity through the generated systematic image 200. Acquiring, generating, and displaying the information of the systematic image is processed through a computer, quickly and accurately. The user can quickly browse and control the operating information of the business entity. It's worth mention that the preferred embodiment is direct selling. In other embodiments, the origin-deriving relationship can be a headquarters-brunch relationship of chain business (the headquarters is the original business entity and the brunch is the derived business entity), a franchiser-franchisee relationship (franchiser is the original business entity and the franchisee is the derived business entity), or a leader-crew relationship of the insurance industry (leader is the original business entity and the crew is the derived business entity). The above relationship can be applied to the present invention. For example for a chain business, A can represent the headquarters and B, C, and D can represent the brunches.

In other embodiments, the derived business entity (the second generation) can be derived from the derived business entity (the first generation). For this condition, the first generation derived business entity is the original business entity relative to the second generation derived business entity. Utilizing the same beaded representation method (the systematic representation method) to form the systematic image 200 having multi-levels beaded bead image. For example, four marking circles A, B, C, and D form circle A which connects with marking circles B, C, and D. In this condition, A represents the original business entity, and B, C, and D represent the first generation derived business entity. For example, in marking circles D, E and F, marking circle D connects with making circles E and F respectively, and in such manner that represents that E and F are derived from D. D is the first generation derived business entity relative to A, but D is the original business entity relative to E or F. E and F are the second generation derived business entity. G, H, I, J, K, and L are the third generation derived business entity. The systematic representation method is capable of clearly representing the origin-deriving relationship between business entities, even though the multi-level derived relationships. On the other hand, the systematic relationship of business entities is able to confirm such that E, F, G, H, I, J, K, and L are directly or indirectly derived from D, so that D, E, F, G, H, I, J, K, and L are the same systematic relationship. The initial original business entity (for example A is shown on FIG. 3B) is preferably, but is not limited to, the user of the electronic device. In other words, when the systematic image 200 is generated through the electronic device, the user prefers, but is not limited to, to be regarded as the initial original business entity. When the systematic image 200 is generated through the electronic device according to the user that is the initial original business entity, the systematic image 200 does not display the original business entity of the user preferably. In order words, if upline of A (as shown on FIG. 3B) is Z, the upline Z is capable of not displaying on the systematic image 200, so that the systematic image 200 is concise.

In the preferred embodiment, the systematic image 200 is displayed by utilizing a differentiation representation in accordance with the operating information of the original business entity and the derived business entity. The differentiation representation is capable of changing the representation of lines, colors and trends, etc. For example, when the operating information of the original business entity and the derived business entity comprises pins, the original business entity image 210 and the derived business entity image 220 is displayed in a differentiation representation method according to the different pins. In the preferred embodiment, as shown in FIG. 3B, the pin of A, D, G, H, I, J, K, L, M, N, and O is “Platinum”, which is represented as a bold circle. The pin of C is “Emerald”, which represents as double bold circle. The pin of E is “Diamond”, which is represented as a double bold circle and inside the circle is filled with oblique lines. B and other without pins are represented by the common circle.

Another example, when the operating information of the original business entity and the derived business entity comprise the date of distribution (like an established date of a command company), the original business entity image 210 and the derived business entity image 220 are represented in a differentiation representation method according to the category of the date of distribution. In the preferred embodiment as shown on FIG. 3B, the date of distribution of P and Q are in 30 days, which is categorized as new distribution and represented in dotted circles, and other dates of distribution over 30 days are represented in common circles. On the other hand, the system image 200 is represented differentially in accordance with the operating information of the original business entity and the derived business entity, but is not limited to the original business entity image 210 and the derived business entity image 220. The connection between the original business entity image 210 and the derived business entity image 220 can also be represented differentiation method. For example, in the preferred embodiment as shown on FIGS. 3B, P, Q, and R are the date of distribution within 30 days and are represented by dotted circles with lineal connections (for example P-B-A, Q-M-C-A, and R-M-C-A) belonging to P, Q and R represented as a parallel line having a common line and a dotted line.

The systematic image 200 is represented differentially in accordance with the operating information content of the original business entity and the derived business entity. The systematic image 200 is not only capable of representing the origin-deriving relationship between the business entities, but is also capable of representing the relative operating information, so that the user controls the operation statess of the business entities more efficiently. For example, because new distributions such as P, Q and R are represented by dotted circles, the distributor A is capable of efficiently noticing that P, Q and R are new distributions by through browsing the systematic image 200 displayed on the electronic device 100. Additionally, because the lineal connection belonging to P, R and Q are represented as a parallel line having a common line and a dotted line, the distributor is capable of noticing efficiently which upline is the upline (the original business entity) of P, Q and R. For example the upline of P is B (P-B-A lineal connection), the first and second generation upline of Q and R is M and C respectively (Q-M-C-A, R-M-C-A are the lineal connections). In usual business operation, especially for direct selling, the new business entities or distributors need to be careful and give advice. In summary, distributor A efficiently controls the new distributions P, Q and R etc., and upline B, M and C etc., whom are the uplines of P, Q and R etc., and A pays more attention to P, Q and R etc., or asks B, M and C to do it, so that the operating results of P, Q and R is improved (for example, the increase of achievements, renewaling rate, or sponsoring rate).

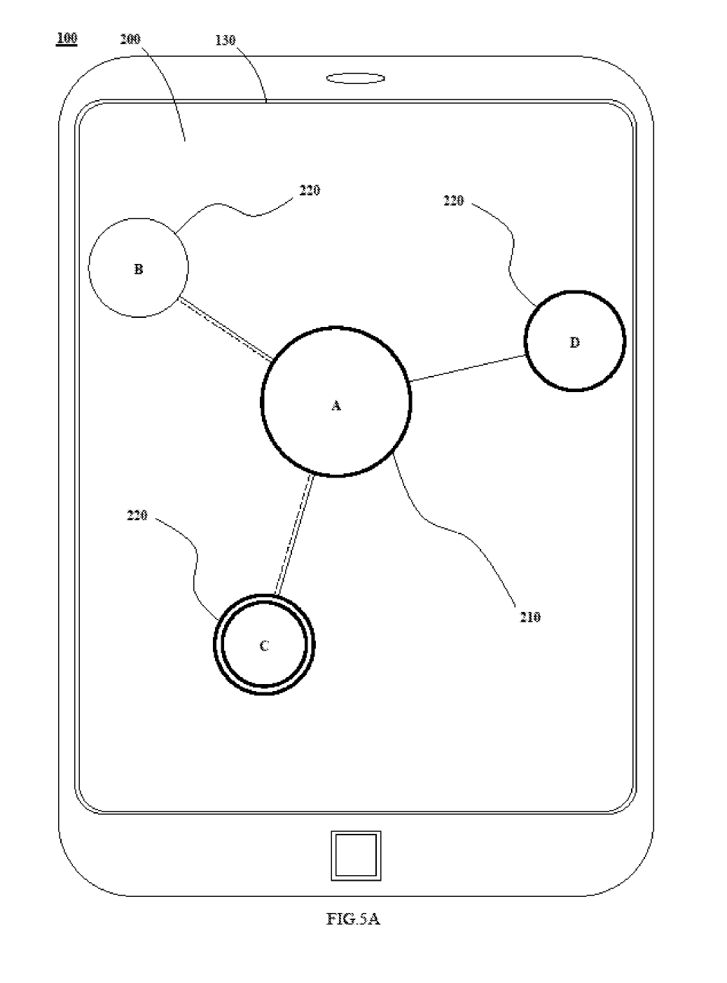

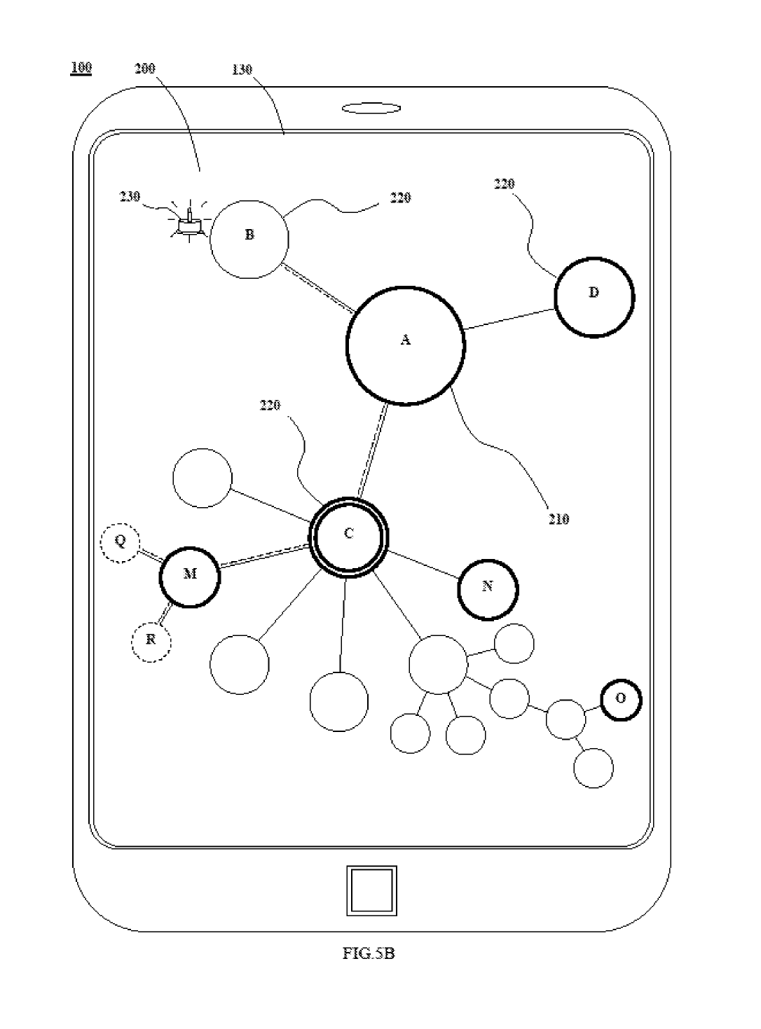

The systematic image 200 is not limited to the beaded image, all images that are capable of being represented in the derived relationship among business entities are acceptable. Another embodiment is represented in FIG. 4A, the systematic image 200 is a planetary-system image, wherein the original business entity image 210 with marking S is regarded as “Star” of “planetary-system”, and the derived business entity images 220 with marking T, U, and V which located on track 901 that surround Star are regarded as “planets” of the “planetary-system”. The original business entity image 210 and the derived business image 220 form the planetary-system image. In other words, in the embodiment in FIG. 4A, the systematic representation means that the original business entity image 210 is regarded as star of the planetary-system, and the derived business entity image 220 is regarded as a planet of the planetary-system which located on the track of the original business entity image 210 periphery, for forming the planetary-system image which is regarded as the systematic image, wherein the derived business entity image 220 locates the track surrounding the original business entity image 210, so the systematic representation is capable of representing the origin-deriving relationship between the original business entity and the derived business entity. The second generation derived business entity is capable of being derived from the first generation derived business entity. In this situation, the first generation derived business entity is the original business entity relative to the second generation derived business entity. Utilizing the same planetary-system representation (the systematic representation) to form multi-levels planetary-system images which are regarded as systematic image 200. More specifically, circle images are marked S, T, U, and V respectively, marking circle images T, U and V located on track 901 surrounding the marking circle image S, which the representation of T, U and V are derived from S. In this situation, S is the original business entity, T, U, and V are the first generation derived from business entity. For example, circle images are marked T, W, X, Y, and Z, and marking circle images W, X, Y and Z are located on a track 902 surrounding the circle image with marking T, which represent W, X, Y and Z which are derived from T. In this condition, T is not only the first generation derived business entity, but also is the original business entity relative to W, X, Y, and Z. W, X, Y, and Z are the second generation derived business entities, and α and β are third generation derived business entities. According to the systematic representation, even if the relationship is a derived multi-level relationship, the origin-deriving relationship among business entities are clearly represented.

Another embodiment as shown on FIG. 4B, the systematic image 200 is a treeform syntax image, wherein the original business entity image 210 with marking t located on the top end. The derived business entity images 220 with marking t1, t2, t3, and t4 are locate on the lower level. The original business entity image 210 and the derived business entity 220 form a treeform syntax image. In other words, in the embodiment shown on FIG. 4B, the systematic representation means that the original business entity image 210 is configured on an upper level, and the derived business entity image 220 is configured on a lower level, wherein the original business entity 210 links to the derived business entity image 220 so as to form treeform syntax image which is regarded as systematic image. Because the derived business entity images 220 upwardly link to the original business entity image 210, the systematic representation is capable of representing the origin-deriving relationship among the original business entities 210 and the derived business entities 220. The second generation derived business entities are derived from the first generation derived business entities, and in this situation, the first generation derived business entities are the original business entities relative to the second generation derived business entities. Utilizing the same treeform syntax representation method (systematic representation method) to form a multi-level treeform syntax image which is regarded as the systematic image 200. For example, rectangles are marked t, t1, t2, t3 and t4 respectively, and marking rectangles t1, t2, t3, and t4 are located on the lower level of marking rectangle t and link upwardly to t respectively for representing that t1, t2, t3 and t4 are derived from t. In this situation, t is the original business entity and t1, t2, t3, and t4 are the first generation derived business entities. For example, rectangles are respectively marked with t4, t41, t42, and marking rectangles t41 and t42 are located on the lower level of marking rectangle t4 which represent that t41 and t42 are derived from t4, and in this situation, t4 is not only the first generation business entity, but also the original business entity relative to t41 and t42, t41 and t42 which are the second generation derived business entities. t421 is the third generation derived business entity. According to systematic representation method, even though the derived business entities are multi-level relationship, the origin-deriving relationship is clearly represented.

The above embodiments, the operating information of the original business entity and the derived business entity are acquired through the electronic device, and the systematic image is generated and displayed through the electronic device. In other embodiments, the systematic image is capable of pre-generating, and then the systematic image is acquired and displayed through the electronic device. For example, as shown on FIG. 2, the systematic image is pre-generated through a computer or a server of the independent headquarters end 300 away from the electronic device. More specifically, the operating information of the original business entity and the derived business entity are capable of being stored in a library (not shown on Figures), wherein the headquarters end 300 connects with the library and acquires the operating information of the original business entity and the derived business entity from the library. The systematic imagine is then generated to represent the origin-deriving relationship among the original business entity images and the derived business entity images in accordance with the original business entity images generated from the operating information of the original business entities and the derived business entity images generated from operating information of the derived business entities. In other embodiments, the first communication channel 410 is established between the headquarters end 300 and the electronic device 100 through the communication device 110. The systematic image is output through the headquarters end 300, transmitted by the first communication channel 410, and acquired through electronic device 100. In other words, in the preferred embodiment, the systematic image is acquired from the headquarters end 300 through the electronic device 100, and displayed through the displaying device. In other embodiments, the immense amount of operating information of the original business entity and the derived business entity require more time and resources to be spent to transmit and process. In accordance with the systematic image generated outside of the electronic device, the workload of the communication device 110, storage device 150, or the arithmetic device 190 of the electronic device is reduced, so that hardware requirement of the electronic device 100 is reduced.

In other views, the steps of generating the systematic image, comprise: the operating information of the original business entity and the derived business entity is generated, and then systematic image is generated. The original business entity and the derived business entity are an origin-deriving relationship. The systematic image comprises the original business entity image in accordance with the operating information of the original business entity and the derived business entity image according with the operating information of the derived business entity. The systematic image representation method represents the original business entities and the derived business entities having the origin-deriving relationship. The systematic image is generated through the electronic device or the headquarters end outside of the electronic device, wherein the systematic image generated outside of the electronic device is capable of being displayed on the electronic device, stored as an electronic file, browsed on the network, or being printed to paper.

In other embodiment, the operation state display method of the present invention further comprises that the derived business entity image are selectively hidden. More specifically, the derived business entity images are hidden selectively and displayed on the displaying device in accordance with a pre-configured or operation of user through the electronic device. For example, the systematic image is capable of pre-configuring to display the first distributors (the first derived business entity) B, C, and D at the beginning through the electronic device as shown on FIG. 3B, and then only B, C, and D are displayed on the electronic device 100 as shown on FIG. 5A. The derived business entity images are selectively hidden except B, C, and D. Alternatively, all derived business entity images are first shown on the electronic device, as shown on FIG. 3B, and then the user selects from the operation list to selectively hide other derived business entity images except B, C, and D on the electronic device. The results is concise systematic image and display acceleration, wherein the original business entity image and the derived business entity image are enlarged and clear, and the goal of filtering out the derived business entity images which the user wants to hide are achieved. On the other hand, according to the operation of the user, part or all of the business entity images are shown on the electronic device 100. For example, when the user selects the derived business entity image C, as showed in FIG. 5A, then the derived business entity images which are derived from C are shown on the electronic device 100, as shown FIG. 5B.

In another embodiment, as shown on FIG. 5B, the operation state display method further comprises a marking image 230 adjacent to the derived business entity image 220, wherein the marking image 230 is generated in accordance with the operation information of the derived business entity. For example, the operating information of the derived business entity comprises the birthday of a distributor. If the date that the distributor A (the original business entity) operates the electronic device 100 to generate systematic image 200 in accordance with the present invention, is the birthday of the distributor B (the derived business entity), then the marking image 230 with a birthday cake is shown on the electronic device 100, as shown on FIG. 5B, until the distributor A notices the date is the birthday of the distributor B and sends congratulations through phone or email, etc. In other words, the marking image 230 is able to further represent a part or contents of the operating information of the derived business entity, distributor B, so that the original business entity, distributor A, is capable of noticing this content quickly. The marking image is preferably displayed near the derived business entity image of the derived business entity in accordance with the operating information of the derived business entity of one of the derived business entities. For example, the marking image 230 with birthday cake is displayed near the business entity image 220 of the distributor B. In the preferred embodiment, the marking image 230 is capable of dynamically displaying, but is not limited this to flickering.

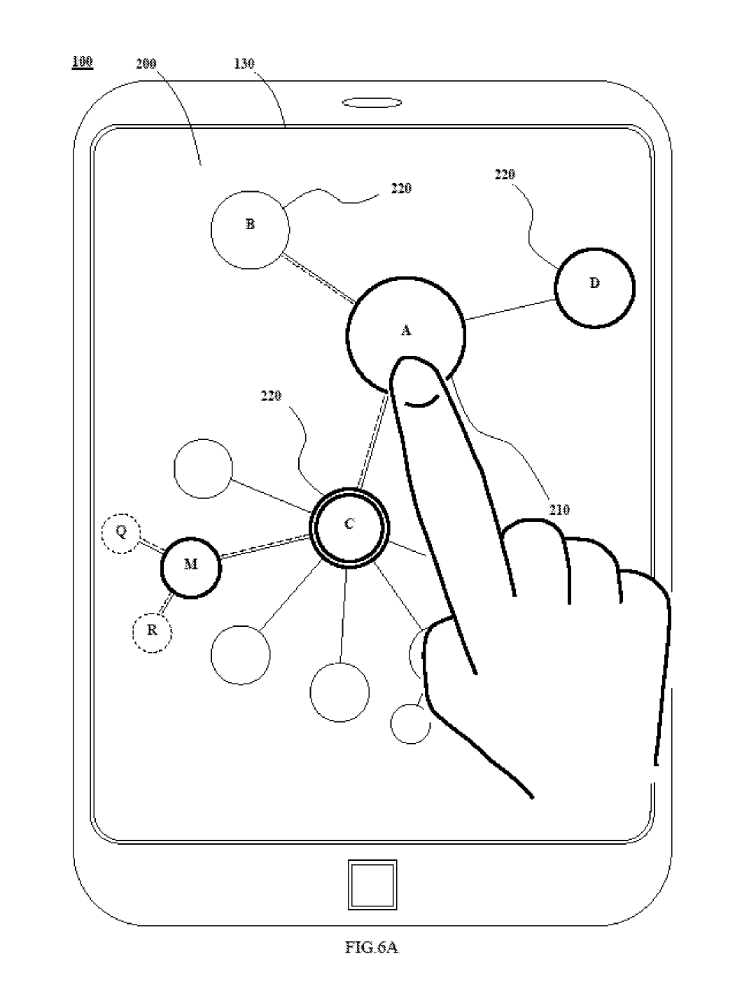

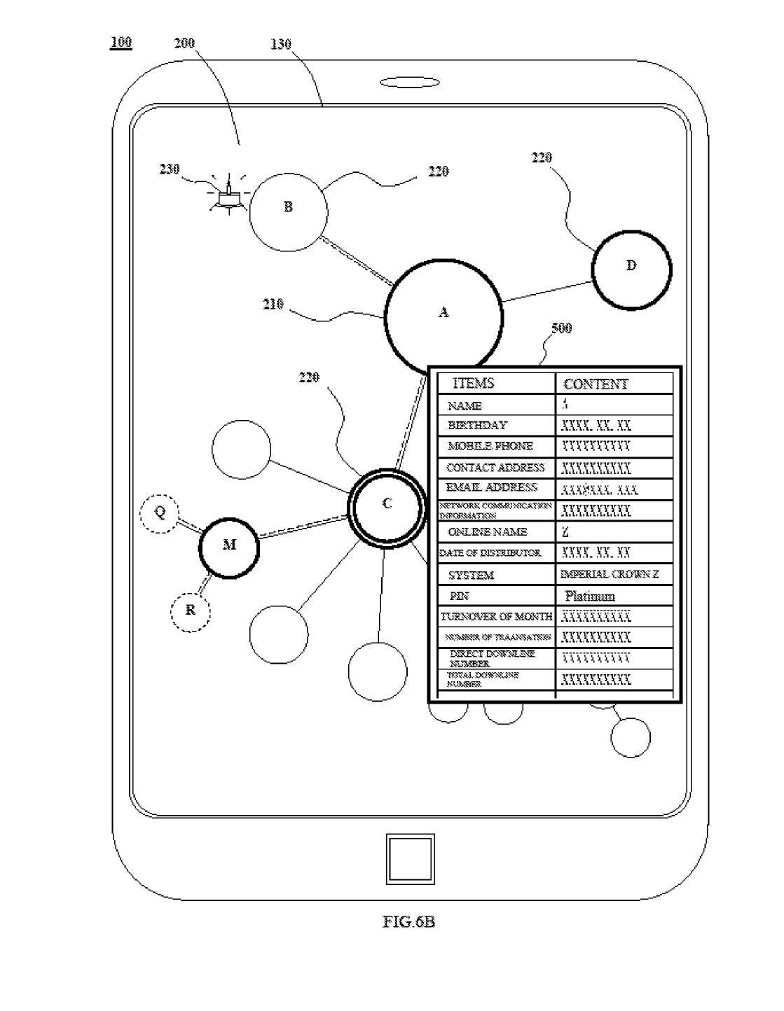

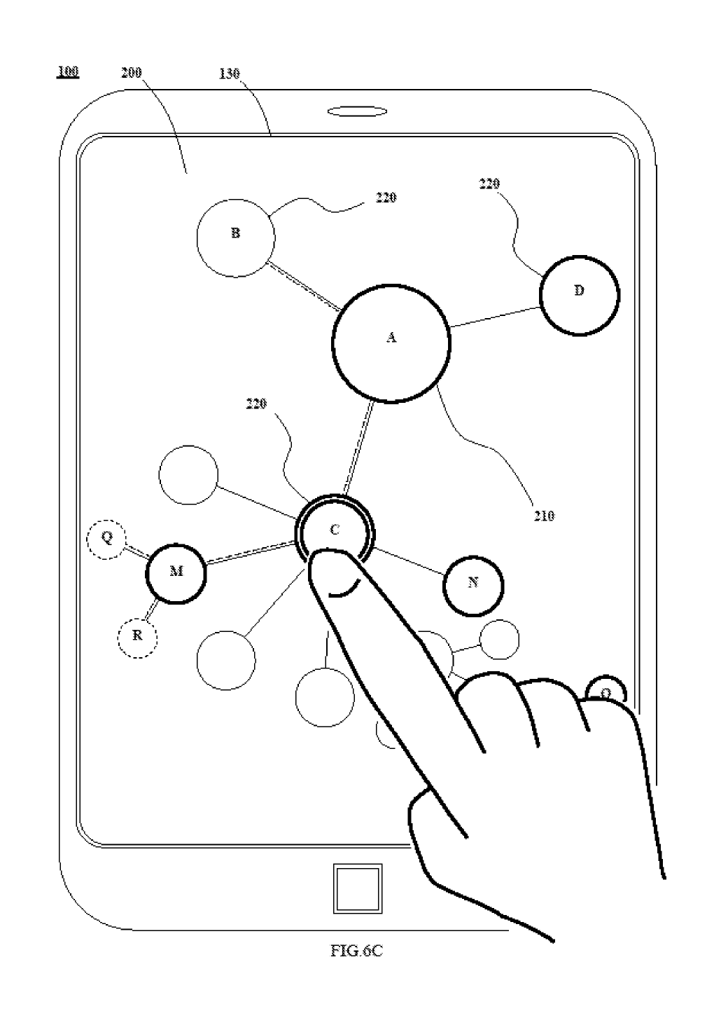

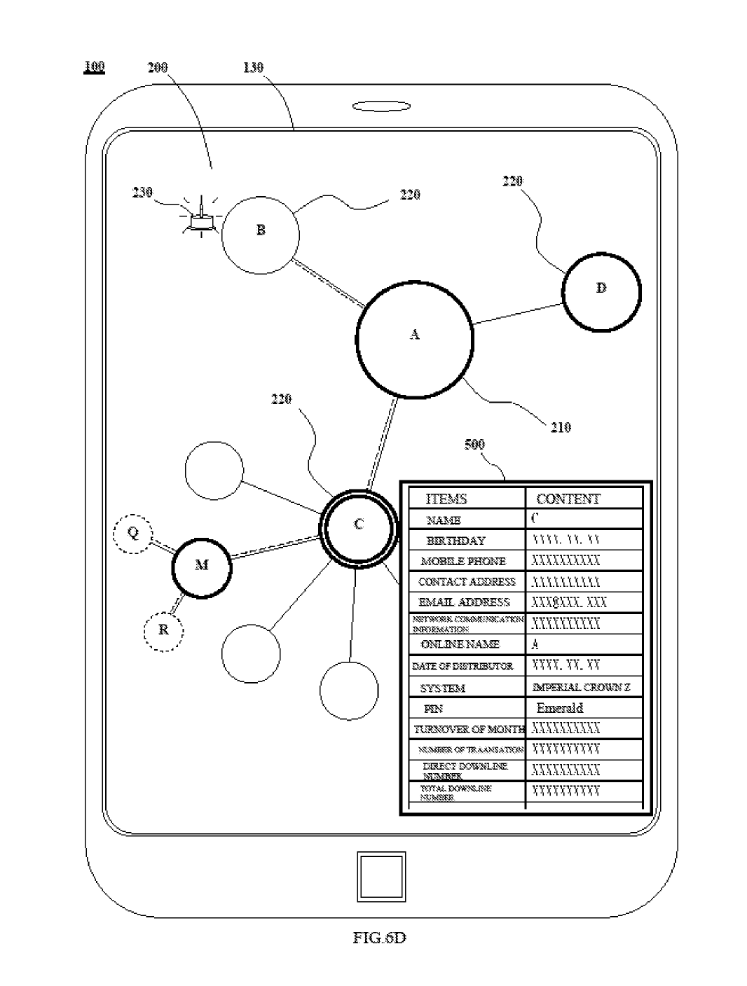

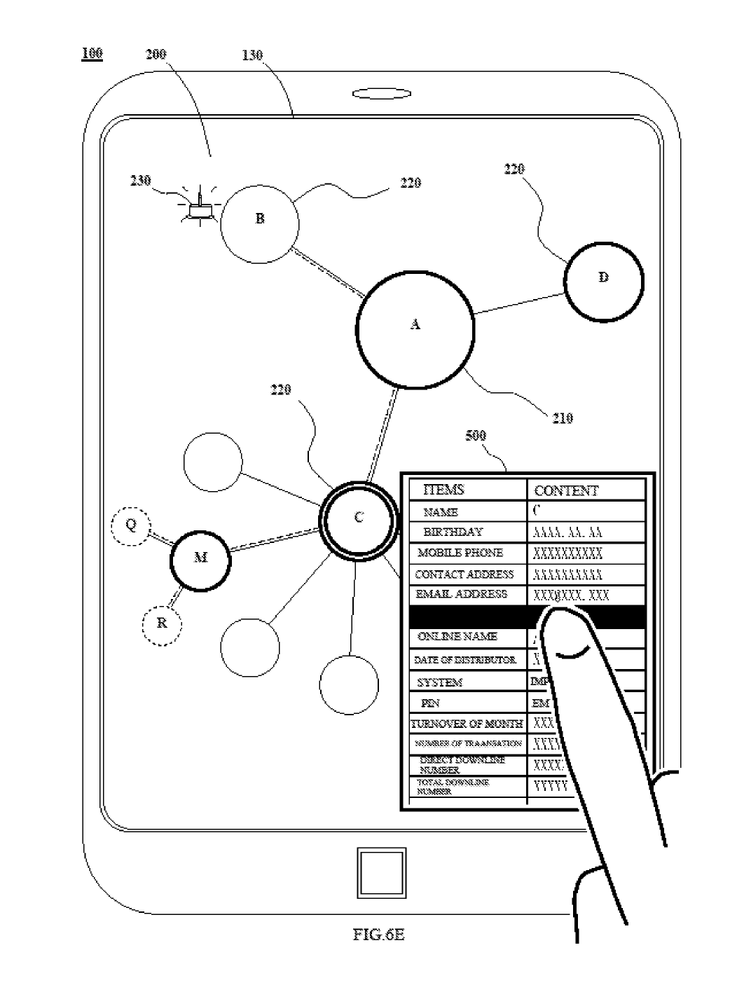

The operating status display method further comprises a selection signal that is detected through the electronic device. The operating information is displayed on the electronic device with the selection signal corresponding to the original business entity image. The embodiment, as shown on FIG. 6A, illustrates the displaying device 130 is preferred as a touch screen. The systematic image 200 is displayed on the touch screen, and the touch screen is capable of detecting the selection signal which is generated when user touches the touch screen. When the user touches the corresponding position displaying the derived business entity image 210 of the distributor A on the touch screen, the selection signal corresponding to the derived business entity image 210 of the distributor A is immediately generated. For this situation, the operating information of the distributor A is displayed by utilizing an information window 500 through the electronic device 100, as shown on FIG. 6B. When the user touches the corresponding position displaying the derived business entity image 220 of the distributor C, as shown on the FIG. 6C, the selection signal corresponds to the derived business entity image 220 of the distributor C. In this situation, the operating information of the distributor C (the derived business entity) is displayed by utilizing the information window 500 through the electronic device 100. In other embodiments, it is not necessary for the displaying device 130 of the electronic device 100 to be able to detect a user's touch. For example, the user is capable of controlling a cursor and navigating it to the position of the derived business entity image 220 of the distributor C by utilizing an optical track ball. In another embodiment, the displaying device 130 comprises a peripheral projector (not shown on Figures), and the electronic device 100 further comprises an action detector (not shown on Figures), wherein the electronic device 100 is capable of generating the selection signal through the action detector or the action of the user.

The operation state display method further comprises the selection signal that is detected through the electronic device. An event is implemented through the electronic device while the selection signals corresponding to one of item contains the operating information of the original business entity or the derived business entity displayed on the electronic device. Part or all of item contains the operating information displayed on the electronic device that has a connection for implementing the event corresponding to the connection through the electronic device. In the embodiment, as shown in FIG. 6D, the content of “network communication information” of the information window 500 has a connection of “implement a network video communication software” (such as SKYPE software), and call the network communication account of the distributor C. When the user touches the corresponding position of the item “network communication information” on the information window 500 displayed on the touch screen, and the selection signal corresponds to the content of item of “network communication information”. At this time, the electronic device 100 implements the event of the above connection, “implement a network video communication software, and call the network communication account of distributor C”, and then establishes a network video chat, so that the user (distributor A) is capable of processing a video chat with the distributor C through the electronic device.

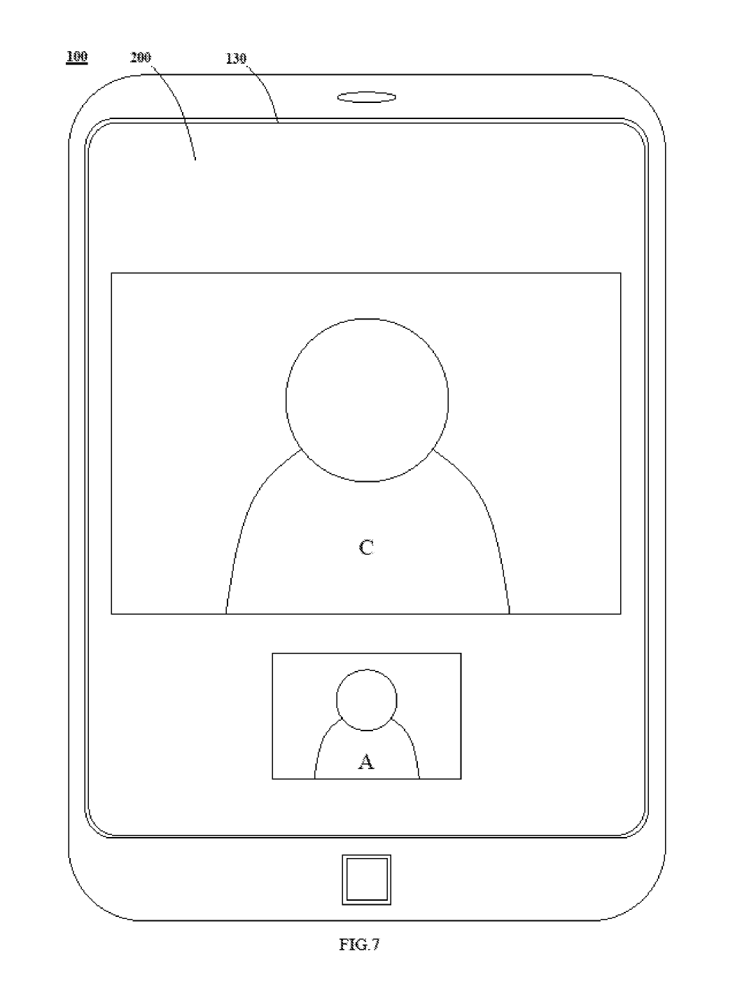

In summary, the user of the electronic device is capable of checking the operation statess of the original business entity and the derived business entity, and allowing the electronic device implement an event through selecting a corresponding item of the operating information of the original business entity and derived business entity displayed on the electronic device, so that operation statess are controlled more efficiently. As shown on FIGS. 6D, 6E and 7, the distributor A notices that the downline Q, R (represented by a dotted circle) are derived from the distributor C when the distributor A browses the systematic image 200. The distributor A is capable of processing a video chat with distributor C quickly according to the embodiment of FIGS. 6D, 6E and 7, to give congratulations to the distributor C for adding a new distributor, or instructing distributor C to pay more attention to Q and R, so that the operational results are increased. In traditional text reports, information regarding that downline Q and R are new distributors would be slow because the text reports are usually printed in time intervals. To contact distributor C, the network communication account of C needs to check the text report first, and then the electronic device with network video communication software is found. Finally the video chat with the distributor C is processed through the electronic device. The previous situation shows that the present invention is more efficient than traditional text based communications.

The above embodiment utilizes the selection signal corresponding to the item “network communication information” as an example, but is not limited to this method.

For example, when the selection signal corresponding to the item “mobile phone”, the mobile phone number of C, the electronic device implements an event that dials the mobile phone number of C so as to establish mobile phone communications with distributor C. In another example, the selection signal corresponding to the item “email”, which corresponds to the email account of the distributor C, wherein the electronic device implements an event that processes an email editor for distributor A to edit and send email to the distributor C. In another example, the selection signal corresponding to the “memorandum”, wherein the distributor A establishes the item record about the distributor C. The electronic device implements the event of running a file editor for the distributor A to edit item records about the distributor C. In the preferred embodiment, the event list displayed on the touch screen is capable of displaying more items of the operating information through the drag event list by the user.

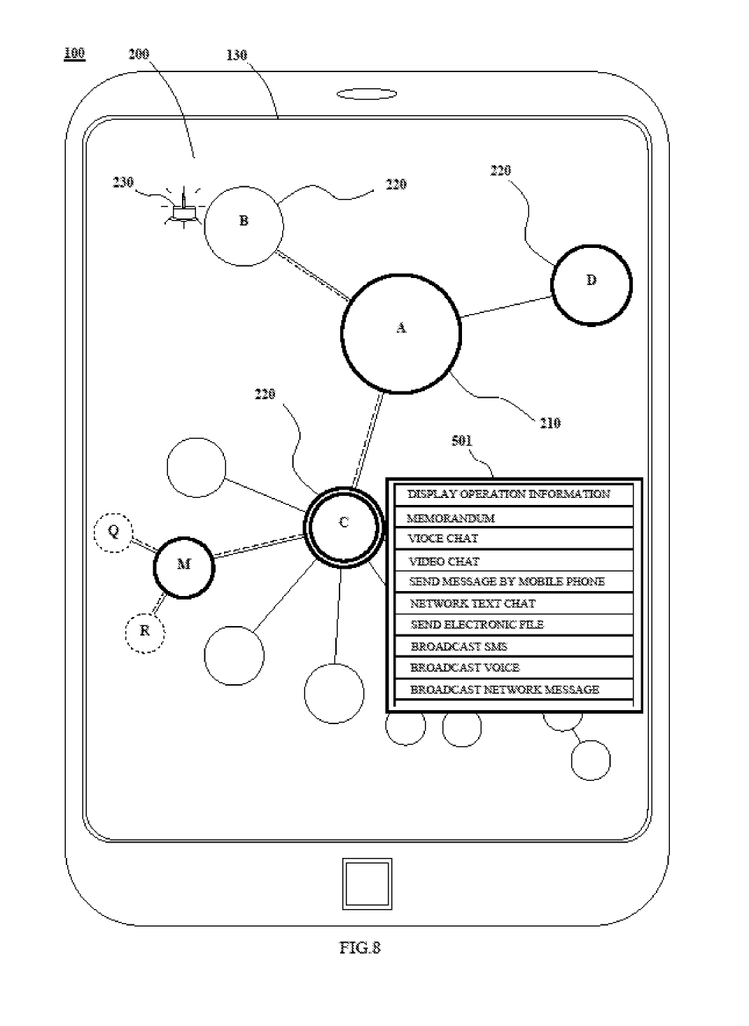

In other embodiments, the operation state display method further comprises the step of the selection signal being detected through the electronic device. The selection signal corresponds to one of the original business entity image or the derived business entity image, and the electronic device provides the event list for the user to select an event implemented through the electronic device. When the user touches the corresponding position of the derived business entity image 220 of the distributor C displayed on the touch screen, the selection signal corresponding to displaying the derived business entity image 220 of the distributor C is generated through the touch screen. At this time, the event list 501 is displayed on the electronic device 100 for the user to select an event implemented through the electronic device, as shown on FIG. 8. For example, when the user's selection is “displaying operating information”, the displaying device displays the operating information of the distributor C, wherein when the user selection is “memorandum”, the electronic device runs the file editor for the distributor A to edit the item records about the distributor C, wherein when the user selection is “voice call”, the electronic device dials the mobile phone number so as to establish mobile phone communication, wherein when the user selection is “network text chat”, the electronic runs network text chat software (for example MSN software) and call the network text chat account of the distributor C so as to establish the network text chat with the distributor C, wherein when the user selection is “message broadcast”, the electronic device sends the mobile phone message to the distributor C and mobile phones of all derived business entities are derived from the distributor C. The event list is not limited to the representation in just text, but the event list is capable of being represented in image.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1. An operation state display method for an electronic device displaying operating information of an original business entity and a derived business entity, wherein said original business entity and said derived business entity have an origin-deriving relationship, wherein said original business entity has a piece of said operation information of said original business entity, wherein said derived business entity has a piece of said operating information of said derived business entity, wherein said operation state display method comprises the steps of:
acquiring said operating information of said original business entity and said derived business entity from said electronic device;
generating a systematic image through said electronic device; and
displaying said systematic image through said electronic device, wherein said step of generating said systematic image through said electronic device further comprises the steps of:
generating an original business entity image in accordance with said operating information of said original business entity through said electronic device;
generating a derived business entity image in accordance with said operating information of said derived business entity through said electronic device; and
configuring a relative position between said original business entity and said derived business entity for forming said systematic image according to a systematic representation method through said electronic device, wherein said system representation method represents said original business entity image and said derived business entity image having said origin-deriving relationship.

2. An operation state display method for an electronic device displaying an operating information of an original business entity and a derived business entity, wherein said original business entity and said derived business entity have an origin-deriving relationship, wherein said original business entity has a piece of said operating information of said original business entity operating information, wherein said derived business entity has a piece of said operating information of said derived business entity, wherein said operation state display method comprises the steps of:
generating a systematic image through an independent peripheral headquarters end outside of said electronic device; and
displaying said systematic image through said electronic device, wherein the step of generating said systematic image through said independent peripheral headquarters end outside of said electronic device further comprises the steps of:
generating an original business entity image in accordance with said operating information of said original business entity through said headquarters end;
generating a derived business entity image in accordance with said operating information of said derived business entity through said independent peripheral headquarters end;
configuring a relative position between said original business entity and said derived business entity for forming said systematic image according to a systematic representation method through said independent peripheral headquarters end, wherein said system representation method represents said original business entity image and said derived business entity image having said origin-deriving relationship; and
acquiring said systematic image through said electronic device.

3. The operation state display method, as recited in claim 1, wherein said step of generating said systematic image further comprises said systematic image having a differentiation representation according to said operating information of said original business entity and said derived business entity.

4. The operation state display method, as recited in claim 1, which further comprises selectively hiding said derived business entity image.

5. The operation state display method, as recited in claim 1, which further comprises displaying a marking image adjacent to said derived business entity image, wherein said marking image is generated in accordance with said operating information of said derived business entity.

6. The operation state display method, as recited in claim 1, further comprising:
detecting a selection signal through said electronic device; and
displaying said operating information of said original business entity through said electronic device while said selection signal corresponds to said original business entity image, wherein said operating information of said derived business entity is displayed through said electronic device with said selection signal corresponding to said derived business entity image.

7. The operation state display method, as recited in claim 6, further comprises:
detecting said selection signal through said electronic device; and
implementing an event through said electronic device when said selection signal corresponds to one or more items of said operating information of said original business entity and said derived business entity.

8. The operation state display method, as recited in claim 1, further comprises:
detecting an selection signal through said electronic device; and
providing an event list for a user to select an event for implementing said event through said electronic device, wherein when said selection signal corresponds to one of said original business entity image or said derived business entity image.

9-10. (canceled)

11. The operation state display method, as recited in claim 1, wherein said systematic image is a beaded image, a planetary system image, or a treeform syntax.

12. A systematic image generation method for implementation though a computer, comprising the steps of:
acquiring an operating information of an original business entity of an original business entity and an operating information of a derived business entity, wherein said original business entity and said derived business entity has an origin-deriving relationship;
generating a systematic image; and
outputting said systematic image, wherein said step of generating said systematic image further comprises the steps of:
generating an original business entity image according to said operating information of said original business entity;
generating a derived business entity image according to said operating information of said derived business entity; and
configuring a relative position between said original business entity and said derived business entity for forming said systematic image according to a systematic representation method through said computer, wherein said system representation method, which represents said original business entity image and said derived business entity image, has said origin-deriving relationship.

13. The systematic image generation method, as recited in claim 12, comprising acquiring said operating information of said original business entity and said derived business entity from a library.

14. The systematic image generation method, as recited in claim 12, further comprising generating a marking image adjacent to said derived entity business image in accordance with said operating information of said derived business entity.

15. The systematic image generation method, as recited in claim 12, wherein said step of outputting said systematic image comprises the steps of: storing said systematic image as an electronic file, transmitting said systematic image to an electronic display device, and transmitting said systematic image to a network for browsing, or a printer for printing.

16-17. (canceled)

18. The systematic image generation method as recited in claim 12, wherein said systematic image is a beaded image, a planetary system image, or a treeform syntax.

19-30. (canceled)

31. The operation state display method, as recited in claim 2, wherein said step of generating said systematic image further comprises said systematic image having a differentiation representation according to said operating information of said original business entity and said derived business entity.

32. The operation state display method, as recited in claim 2, which further comprises selectively hiding said derived business entity image.

33. The operation state display method, as recited in claim 2, which further comprises displaying a marking image adjacent to said derived business entity image, wherein said marking image is generated in accordance with said operating information of said derived business entity.

34. The operation state display method, as recited in claim 2, further comprising:
detecting a selection signal through said electronic device; and
displaying said operating information of said original business entity through said electronic device while said selection signal corresponds to said original business entity image, wherein said operating information of said derived business entity is displayed through said electronic device with said selection signal corresponding to said derived business entity image.

35. The operation state display method, as recited in claim 34, further comprises:
detecting said selection signal through said electronic device; and
implementing an event through said electronic device when said selection signal corresponds to one or more items of said operating information of said original business entity and said derived business entity.

36. The operation state display method, as recited in claim 2, further comprises:
detecting an selection signal through said electronic device; and
providing an event list for a user to select an event for implementing said event through said electronic device, wherein when said selection signal corresponds to one of said original business entity image or said derived business entity image.

37. The operation state display method, as recited in claim 2, wherein said systematic image is a beaded image, a planetary system image, or a treeform syntax.
